(19) United States
(12) Patent Application Publication
(10) Pub. No.: US 2018/0063178 A1
(43) Pub. Date: Mar. 1, 2018

(54) METHOD AND SYSTEMS FOR REAL-TIME INTERNAL NETWORK THREAT DETECTION AND ENFORCEMENT

(71) Applicant: Promithius Inc., San Francisco, CA (US)

(72) Inventors: Nishant Jadhav, Santa Clara, CA (US); Sheetalkumar Doshi, Fremont, CA (US); Kevin Buchanan, San Francisco, CA (US)

(21) Appl. No.: 15/694,727

(22) Filed: Sep. 1, 2017

Related U.S. Application Data
(60) Provisional application No. 62/382,757, filed on Sep. 1, 2016.

(51) Int. Cl. H04L 29/06; H04L 12/741

(52) U.S. Cl. CPC H04L 63/1425; H04L 45/74; H04L 63/1416

(57) ABSTRACT

A method for threat detection and enforcement in an internal network is disclosed. The method includes: receiving a network packet of a plurality of network packets for a traffic flow; inspecting the network packet to obtain packet information; generating, using the packet information, a flow identifier (ID) for the traffic flow; assigning, based on the flow ID, a trust score and a risk score for the network packet; and performing an enforcing action, applicable to the traffic flow, based on the trust score and risk score.

### CROSS-REFERENCE TO RELATED APPLICATIONS

This application claims priority under 35 U.S.C. § 119(e) to U.S. Provisional Patent Application No. 62/382,757, filed on Sep. 1, 2016, and entitled “Method and Systems for Real-Time Internal Network Threat Detection and Enforcement.” U.S. Provisional Patent Application No. 62/382,757 is hereby incorporated in its entirety.

### BACKGROUND

Traditional approaches for securing an internal network focus heavily on endpoint protection and security information and event management (SIEM) solutions. With the advent of the Internet of Things (IoT) within the enterprise network, the installment of computing-heavy endpoint protection on lightweight IoT devices is impractical. Therefore, not all internal network endpoints can be protected through employment of these traditional approaches, thereby identifying IoT devices within the internal network as prime targets for the execution of network threats, such as the siphoning of corporate and/or personal data and the introduction of viruses, etc.

### SUMMARY

In general, in one aspect, the invention relates to a method for threat detection and enforcement in an internal network. The method comprises: receiving a network packet of a plurality of network packets for a traffic flow; inspecting the network packet to obtain packet information; generating, using the packet information, a flow identifier (ID) for the traffic flow; assigning, based on the flow ID, a trust score and a risk score for the network packet; and performing an enforcing action, applicable to the traffic flow, based on the trust score and risk score.

In general, in one aspect, the invention relates to a segment enforcer. The segment enforcer comprises: a decision engine executing on a computer processor and configured to: receive a network packet of a plurality of network packets for a traffic flow; inspect the network packet to obtain packet information; generate, using the packet information, a flow identifier (ID) for the traffic flow; assign, based on the flow ID, a trust score and a risk score for the network packet; and perform an enforcing action, applicable to the traffic flow, based on the trust score and risk score.

In general, in one aspect, the invention relates to a system. The system comprises: an internal network comprising a plurality of segments and a plurality of segment enforcers; and an external network operatively connected to the internal network, and comprising a cloud intelligence center (CIC) and an external network portion of a third-party solution.

In general, in one aspect, the invention relates to a method for graph-based anomaly detection. The method comprises: generating, for an internal network, a connection graph representation of the internal network comprising a plurality of nodes and a plurality of edges; maintaining, for each edge of the plurality of edges, a plurality of traffic flow metrics based on real-time observations of traffic in the internal network; detecting an anomaly pattern based on at least one traffic flow metric of the plurality of traffic flow metrics; and identifying a traffic anomaly based on the anomaly pattern.

### BRIEF DESCRIPTION OF DRAWINGS

FIGS. 1A and 1B show systems in accordance with one or more embodiments of the invention.

FIG. 2 shows a segment enforcer in accordance with one or more embodiments of the invention.

FIGS. 3A, 3B, and 3C show flowcharts describing a method for internal network threat detection and enforcement in accordance with one or more embodiments of the invention.

FIG. 3D shows a flowchart describing a method for updating local intelligence in accordance with one or more embodiments of the invention.

FIG. 4 shows a flowchart describing a method for adjusting score weights in accordance with one or more embodiments of the invention.

FIG. 5 shows an internal network graph in accordance with one or more embodiments of the invention.

FIGS. 6 and 7 show exemplary systems in accordance with one or more embodiments of the invention.

FIGS. 8A and 8B show computing systems in accordance with one or more embodiments of the invention.

### DETAILED DESCRIPTION

Specific embodiments of the invention will now be described in detail with reference to the accompanying figures. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In the following description, any component description with regard to a figure, in various embodiments of the invention, may be equivalent to one or more like-named components described with regard to any other figure. For brevity, descriptions of these components will not be repeated with regard to each figure. Thus each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to a method and a system for real-time internal network threat detection and enforcement. Specifically, one or more embodiments of the invention employs multiple segment enforcers strategically positioned throughout an internal network. In conjunction with a cloud intelligence center (CIC) outside the internal network (e.g., residing on an external network), the multiple segment enforcers monitor and rate traffic flows traversing between segments of the internal network. Traffic flows are subsequently allowed to proceed towards a destination or blocked based on the rating determined for a traffic flow, which incorporates a trust score and a risk score. Furthermore, the trust/risk scores are determined and/or updated over time using score weights obtained from the CIC, which are in turn, determined and/or updated over time based on threat intelligence received from one or more third-party solutions and/or telemetry from one or more of the segment enforcers. Also disclosed is a method for traffic anomaly detection using a connection graph representation of an internal network.

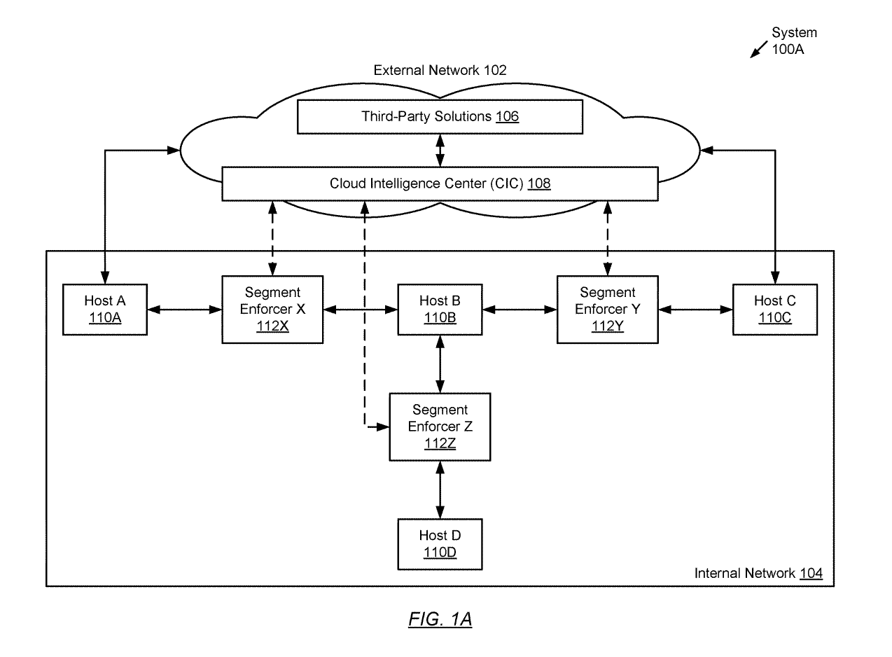

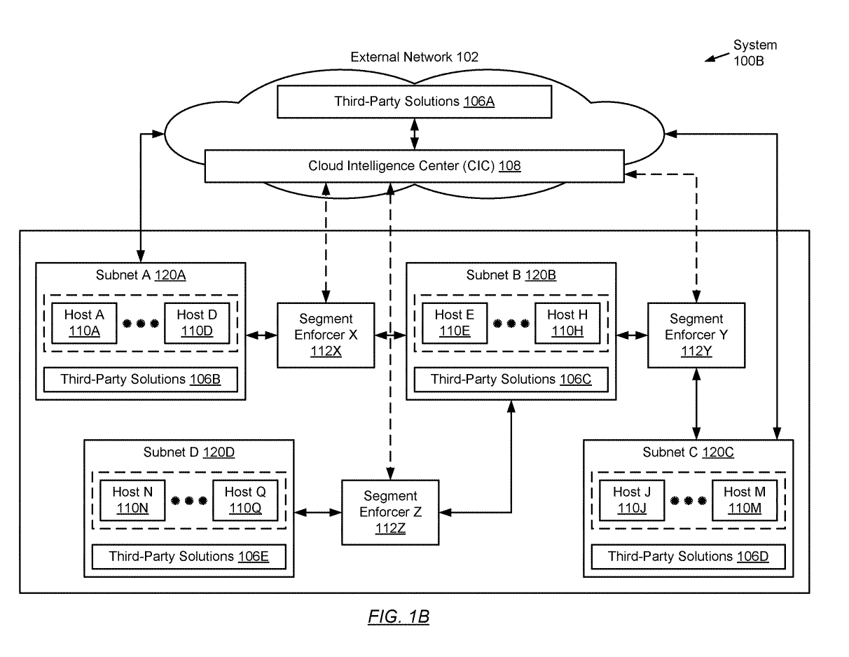

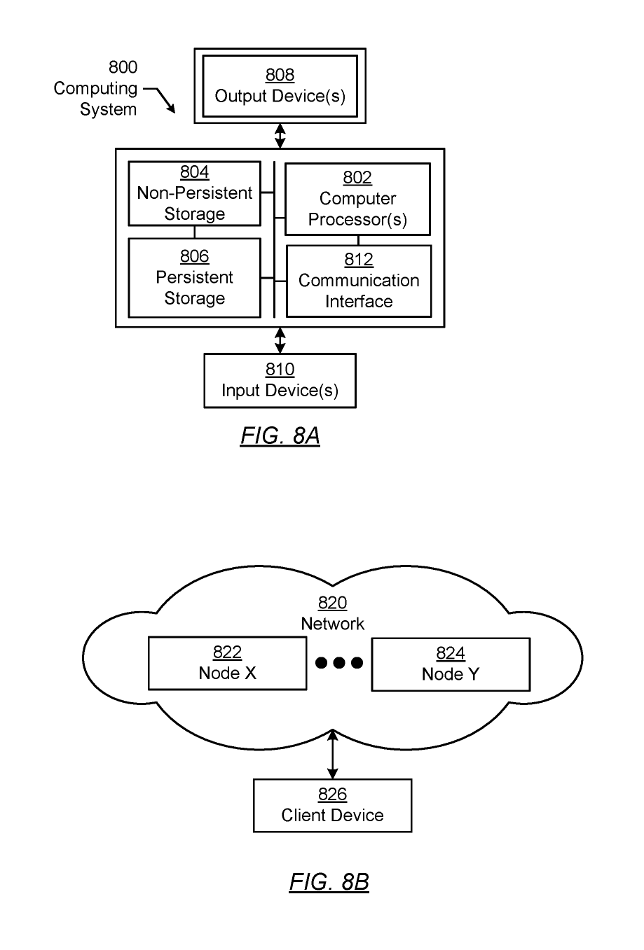

FIG. 1A shows a system in accordance with one or more embodiments of the invention. The system (100A) includes components residing in an external network (102) operatively connected to components residing in an internal network (104). In one embodiment of the invention, an external network (102) may be a set of two or more interconnected computing systems (see e.g., FIG. 8A and FIG. 8B) that reside outside an established network security perimeter (e.g., the internal network (104)). In one embodiment of the invention, an external network (102) may be any publicly accessible communication network, such as the Internet. The external network (102) includes one or more third-party solution(s) (106) and a cloud intelligence center (CIC) (108). Each of these components is described below.

In one embodiment of the invention, a third-party solution (106) may be a pre-existing/employed network security provider, which services the internal network (104). In another embodiment of the invention, a third-party solution (106) may be an in-house or proprietary network security system implemented by administrators of the internal network (104). Further, in yet another embodiment of the invention, a third-party solution (106) may be a publicly accessible/available resource or repository of constantly updated threat intelligence. In one embodiment of the invention, threat intelligence refers to consolidated information regarding, but not limited to, network policy violations, malicious or suspicious activities, data traffic anomalies, network intrusions, virus detections, etc. Examples of a third-party solution (106) include, but are not limited to, an endpoint security tool, an intrusion detection system (IDS), a security information and event management (SIEM) system, a threat rating system, a statistical anomaly detection (AD) system, a vulnerability scanning tool, etc., or any combination thereof.

In one embodiment of the invention, a third-party solution (106) may be representative of hardware, software, firmware, or any combination thereof. In one embodiment of the invention, a third-party solution (106) may be hosted on a physical server (e.g., in a data center, or on a virtual server that may be cloud-based). Subsequently, a third-party solution (106) may be hosted on a single server, or alternatively, on multiple servers that are physical, virtual, or a combination thereof. Further, in one embodiment of the invention, a portion of a third-party solution (106) may be hosted on one or more server(s) residing on the external network (102), whereas another portion of a third-party solution (106) may be hosted on one or more server(s) residing in the internal network (104) (see e.g., FIG. 1B). In another embodiment of the invention, a third-party solution (106) may be hosted on, or deploy as, one or more of any computing system similar to the exemplary computing system shown in FIG. 8A and FIG. 8B.

In one embodiment of the invention, a third-party solution (106) may include functionality to: (i) monitor internal and/or external network activity; (ii) evaluate threats originating from within the internal network (104) and/or threats originating from amongst the external network (102); (iii) gather or consolidate threat intelligence based at least on the aforementioned monitoring of activity and the evaluating of threats; (iv) alert network administrators of threats to the internal network (104) based on the consolidated threat intelligence; and (v) collaborate (e.g., share threat intelligence) with the CIC (108) and/or the one or more segment enforcer(s) (112X, 112Y, 112Z) (discussed below). In one embodiment of the invention, a third-party solution (106) may lack the infrastructure and/or capability to actively terminate or block connections, or otherwise enforce the containment and/or prevention of threats.

In one embodiment of the invention, the CIC (108) may be hardware, software, firmware, or any combination thereof that manages a set of segment enforcers (112X, 112Y, 112Z). In one embodiment of the invention, the CIC (108) may be a physical computing system (see e.g., FIG. 8A and FIG. 8B), such as, for example, a server (i.e., a system with at least one or more processor(s), memory, and an operating system) that is operatively connected to one or more of the third-party solution(s) (106) and the set of segment enforcers (112X, 112Y, 112Z).

In one embodiment of the invention, the CIC (108) may be a physical, special purpose computing system that includes one or more application-specific processor(s) (or hardware) configured to only execute embodiments of the invention. In such an embodiment, the special purpose computing system may be implemented as a family of circuits and may retain limited functionality to receive input and/or generate output in accordance with various embodiments of the invention. In another embodiment of the invention, the CIC (108) may correspond to a physical computing system that includes one or more general purpose processor(s) and one or more application-specific processor(s) (or hardware). In such an embodiment, one or more portion(s) of the CIC (108) may be implemented using the operating system and general purpose processor(s), while one or more portion(s) of the CIC (108) may be implemented using the application-specific processor(s) (or hardware).

In one embodiment of the invention, the CIC (108) may be a virtual machine. In general, virtual machines are distinct operating environments configured to inherit underlying functionality of the host operating system (and access to the underlying host hardware) via an abstraction layer. In one embodiment of the invention, a virtual machine includes separate instances of an operating system, which is distinct from the host operating system. For example, one or more embodiments of the invention may be implemented on VMware® architecture involving: (i) one or more virtual machines executing on a host computer system such that each virtual machine serves as a host to an instance of a guest operating system; and (ii) a hypervisor layer serving to facilitate intra-host communication between the one or more virtual machines and the host computer system hardware. Alternatively, one or more embodiments of the invention may be implemented on Xen® architectures involving: (i) a control host operating system (e.g., Dom 0) including a hypervisor; and (ii) one or more virtual machines (e.g., Dom U) executing guest operating system instances. VMware® is a registered trademark of VMware, Inc. Xen® is a trademark overseen by the Xen Project Advisory Board.

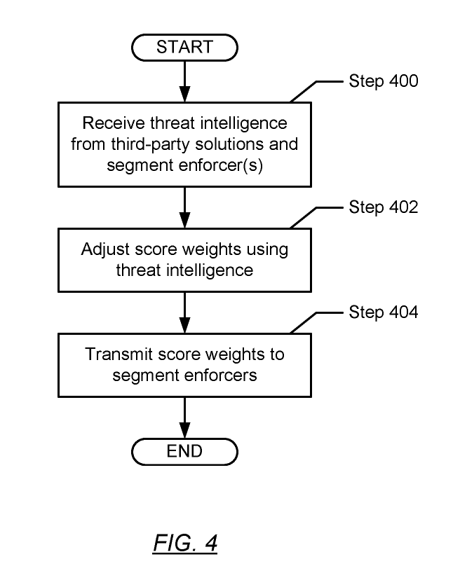

In one embodiment of the invention, the CIC (108) may be implemented in a virtual machine executing on a server that is operatively connected to one or more third-party solution(s) (106) and the set of segment enforcers (112X, 112Y, 112Z). In one embodiment of the invention, the CIC (108) includes executable instructions (stored in non-transitory computer readable medium), which when executed, enable the CIC (108) to perform methods described below (see e.g., FIG. 4). Accordingly, the CIC (108) may include functionality to: (i) receive/obtain and consolidate threat intelligence from one or more third-party solution(s) (106); (ii) receive/obtain and consolidate telemetry (e.g., flow ID, trust and risk scores, etc.) (discussed below) from one or more segment enforcer(s) (112X, 112Y, 112Z); (iii) adjust score weights (discussed below) using the received/obtained threat intelligence and/or telemetry; and (iv) disseminate information pertinent to one or more embodiments of the invention (e.g., the adjusted score weights, the received/obtained telemetry, etc.) to one or more segment enforcer(s) (112X, 112Y, 112Z).

In one embodiment of the invention, an internal network (104) may be a set of two or more interconnected computing systems (see e.g., FIG. 8A and FIG. 8B) that reside within an established network security perimeter. In one embodiment of the invention, an internal network (104) may be any communication network, such as an intranet, which maintains access restricted to a defined set of users. For example, an internal network (104) may be a private network accessed only by the employees of a particular company or enterprise. Further, the defined set of users (e.g., employees) may acquire access to resources that may otherwise not be available to the public. The internal network (104) includes one or more host(s) (110A, 110B, 110C, 110D) and one or more segment enforcer(s) (112X, 112Y, 112Z). Each of these components is described below.

In one embodiment of the invention, a host (110A, 110B, 110C, 110D) may be any computing system (see e.g., FIG. 8A and FIG. 8B) or a virtual machine (described above) executing on any computing system. Regardless of the implementation, a host (110A, 110B, 110C, 110D) may include functionality to generate, transmit, and/or receive data packets. A host may perform additional or alternative functionalities without departing from the scope of the invention.

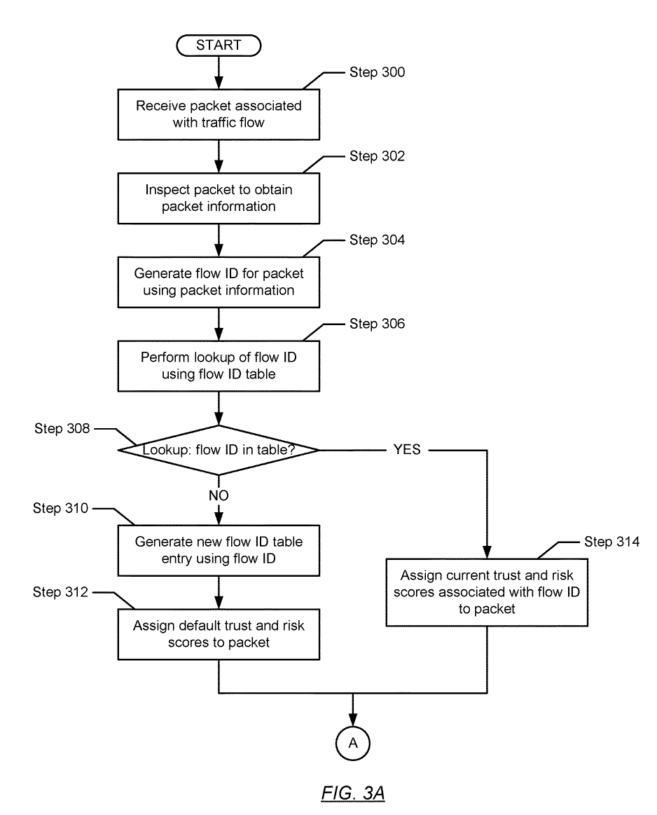

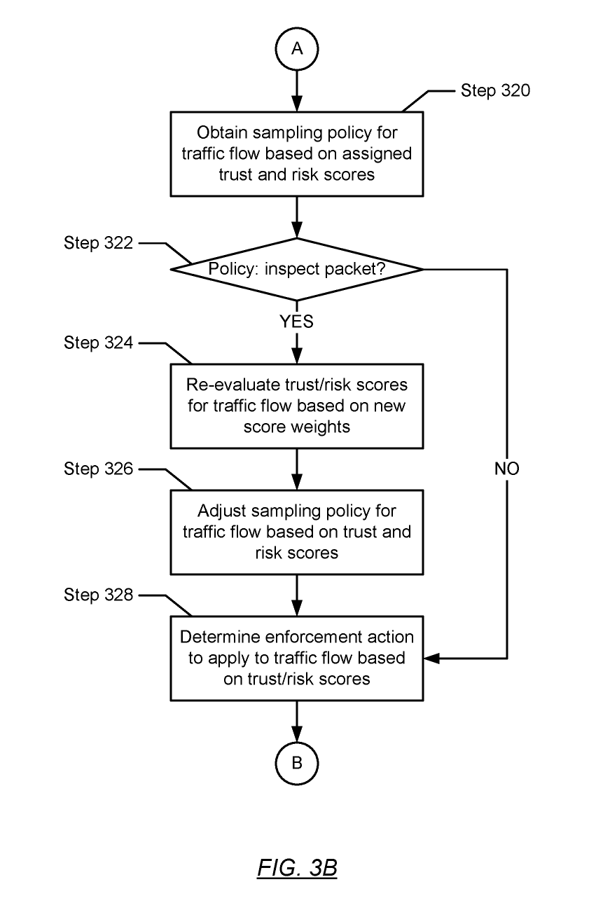

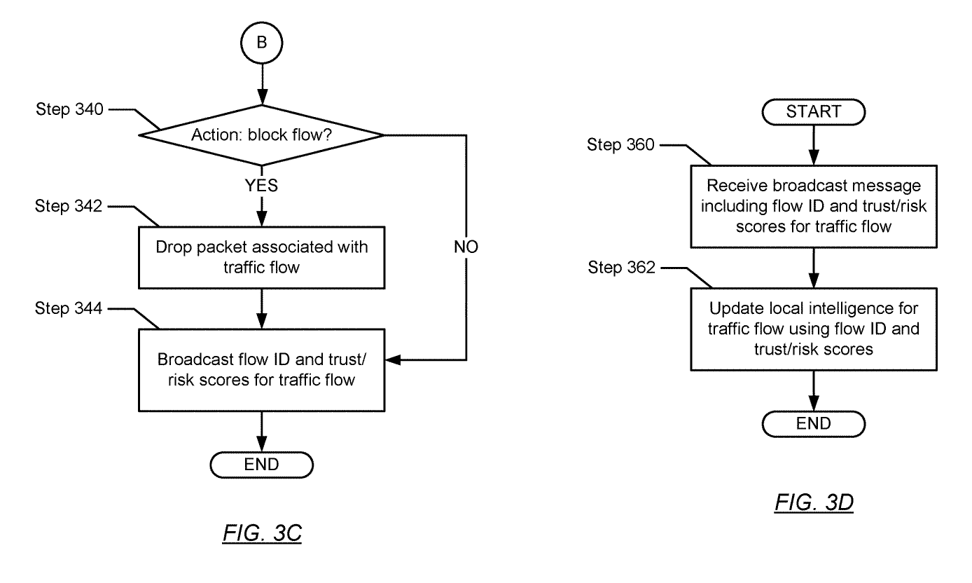

In one embodiment of the invention, a segment enforcer (112X, 112Y, 112Z) may be a network appliance, or a specialized computing system deployed within an internal network (104). Further, in such an embodiment, a segment enforcer (112X, 112Y, 112Z) may include one or more application-specific processor(s) (or hardware) that may be configured to execute only embodiments of the invention (see e.g., FIG. 3A, FIG. 3B, FIG. 3C, and FIG. 3D). In another embodiment of the invention, a segment enforcer (112X, 112Y, 112Z) may be a virtual machine (described above). In such an embodiment, a segment enforcer (112X, 112Y, 112Z) may execute over underlying hardware pertaining to any computing system (see e.g., FIG. 8A and FIG. 8B) representative of the internal network (104) infrastructure (e.g., a host (110A, 110B, 110C, 110D), a network device (not shown), etc.). In one embodiment of the invention, a network device may include, but is not limited to, a switch, a bridge, a hub, a router, and a multilayer switch. In one embodiment of the invention, a segment enforcer (112X, 112Y, 112Z) may be operatively connected to the CIC (108), one or more other segment enforcer(s), and/or additional components of the internal network (104) (e.g., hosts (110A, 110B, 110C, 110D), network devices (not shown), portions of third-party solution(s) residing within the internal network (104) (see e.g., FIG. 1B), etc.).

In one embodiment of the invention, one or more segment enforcer(s) (112X, 112Y, 112Z) may be deployed at strategic positions throughout the internal network (104). In one embodiment of the invention, a strategic position may correspond to a location within the internal network (104) that provides a segment enforcer visibility to the east-west traffic flowing within a segment of the internal network (104). In one embodiment of the invention, a segment of the internal network (104) may correspond to, for example, a virtual local area network (VLAN), a subnet, or a local network. Examples of where within the internal network (104) a segment enforcer (112X, 112Y, 112Z) may be deployed (adjacent to or on) include, but are not limited to, a network device with a switch port analyzer (SPAN) port, a network device with a test access point (TAP) port, a network device or host employing a raw socket and/or packet capture mechanism (e.g., an application program interface (API)), a network device or host employing a traffic exchanging mechanism (e.g., a web caching and/or control protocol), at the access or distribution layer of the internal network (104) where traffic is aggregated, within an isolated network environment (e.g., corresponding to the industrial internet of things (IIoT) architecture/framework), etc.

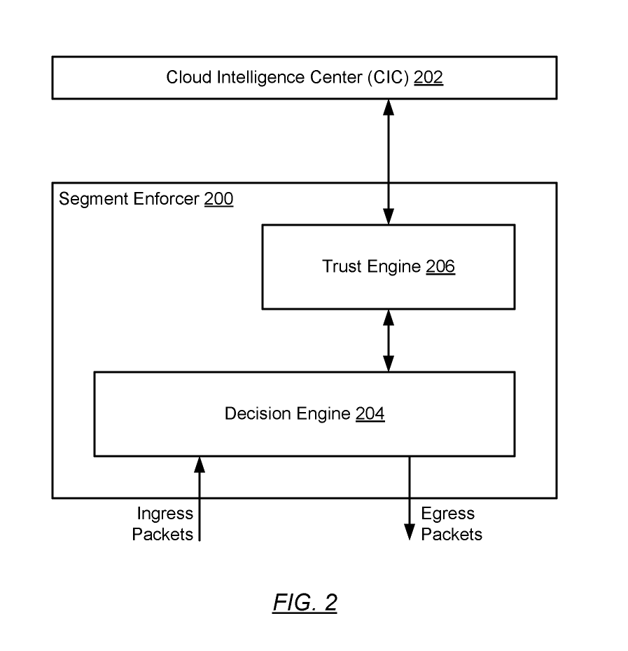

In one embodiment of the invention, a segment enforcer (112X, 112Y, 112Z) may include functionality to: (i) inspect the traffic flows within the segment of the internal network (104) in which it is installed; (ii) generate/evaluate trust and risk scores for the set of hosts, the set of applications, and the set of traffic flows within their respective segment; (iii) ingest feeds and logs from third-party solution(s) (106) in order to perform (ii); (iv) share/disseminate traffic flow information (e.g., flow ID, etc.) and trust/risk scores with the CIC (108) and other segment enforcers (112X, 112Y, 112Z); and (v) block threat-inflicted/infected traffic flows, drop corresponding packets, or enact any other enforcement action in accordance with embodiments of the invention. In one embodiment of the invention, the segment enforcers may communicate directly with each other (i.e., not via the CIC). The segment enforcer is discussed in further detail below with respect to FIG. 2.

FIG. 1B shows a system in accordance with one or more embodiments of the invention. The system (100B) of FIG. 1B is substantively similar to the system (100A) depicted in FIG. 1A, and thus shares some components (e.g., external network (102), third-party solutions (106), CIC (108), internal network (104), segment enforcers (112X, 112Y, 112Z), etc.) that are substantively similar to respective components disclosed within FIG. 1A. With regards to differences, the system (100B) of FIG. 1B includes one or more subnet(s) (120A, 120B, 120C, 120D) in place of the one or more host(s) (110A, 110B, 110C, 110D) of FIG. 1A.

In one embodiment of the invention, a subnet (120A, 120B, 120C, 120D) may be a logical subgroup of interconnected computing systems within the internal network (104). Accordingly, in one embodiment of the invention, a subnet (e.g., 120A) includes a set of hosts (e.g., 110A-110D). In one embodiment of the invention, a subnet (e.g., 120A) additionally includes the internal network resident portions of one or more third-party solution(s) (e.g., 106B) (discussed above). In one embodiment of the invention, a subnet (120A, 120B, 120C, 120D) further includes one or more network device(s) (not shown), which may facilitate the interconnectivity and resource/information exchange between computing systems within the subnet.

The invention is not limited to the systems shown in FIG. 1A and FIG. 1B.

FIG. 2 shows a segment enforcer in accordance with one or more embodiments of the invention. The segment enforcer (200) includes a decision engine (204) operatively connected to a trust engine (206), which in turn is operatively connected to the CIC (202). Each of these components is described below.

In one embodiment of the invention, the decision engine (204) may be any hardware (e.g., circuitry), software, firmware, and/or any combination thereof that includes functionality to obtain, process, classify, and/or drop/allow network packets. In one embodiment of the invention, the decision engine (204) may execute software instructions in the form of non-transitory computer readable program code described in detail below, with reference to FIG. 3A, FIG. 3B, FIG. 3C, and FIG. 3D. The instructions, when executed by a computer processor (e.g., an integrated circuit), may enable the decision engine (204) to: (i) obtain/ingest network packets (e.g., ingress packets); (ii) classify network packets as belonging to particular traffic flows; (iii) assign trust and risk scores to the network packets; (iv) samples network packets based on a sampling policy for the traffic flow to which the network packets are associated; (v) executes an enforcing action (e.g., block or allow) impacting traffic flows and/or network packets based at least on trust and risk scores; (vi) shares information (e.g., trust and risk scores, enforcing actions, etc.) with the CIC (202) and other segment enforcers; and (vii) receives shared information and/or threat intelligence from the CIC (202) and other segment enforcers.

In one embodiment of the invention, the trust engine (206) may be any hardware (e.g., circuitry), software, firmware, and/or any combination thereof that includes functionality to assess threat levels presented by network packets and/or traffic flows. In one embodiment of the invention, the trust engine (206) may execute software instructions in the form of non-transitory computer readable program code described below, with reference to FIG. 3B. The instructions, when executed by a computer processor (e.g., an integrated circuit), may enable the trust engine (206) to: (i) receive/obtain score weights (discussed below) from the CIC (202); (ii) calculate/re-evaluate trust and risk scores for network packets and/or traffic flows based on the score weights and/or threat intelligence from one or more third-party solution(s) (see e.g., FIG. 1A and FIG. 1B) and other segment enforcers; and (iii) provide calculated/re-evaluated trust and risk scores to the decision engine (204), the CIC (202), and/or other segment enforcers deployed throughout the internal network.

In one embodiment of the invention, the segment enforcer (200) may further include one or more data repositories (not shown). In one embodiment of the invention, a data repository may be any type of storage unit, data structure, and/or device (e.g., file system, database, collection of tables, or any other storage mechanism) for storing information. In one embodiment of the invention, the information stored may include a set of payload/packet signatures (discussed below), each corresponding to a known application (described below). In such an embodiment, an initial set of payload/packet signatures may be preloaded onto the segment enforcer (200) upon its installment within the internal network. Further to such an embodiment, the set of payload/packet signatures may be periodically updated using information disseminated to the segment enforcer (200) by the CIC (202). In one embodiment of the invention, the information stored in a data repository may include one or more lookup table(s) (e.g., a flow ID table) relating identifying information unique to a traffic flow (e.g., flow ID, etc.) and current values for trust/risk scores corresponding to that traffic flow. In such an embodiment, the one or more lookup table(s) may be structured as a set or list of key-value pairs, wherein each key-value pair may be representative of information pertaining to a specific, previously identified traffic flow. Further to such an embodiment, a traffic flow identifier may be designated as the key in the key-value pair, whereas the current trust/risk scores for the traffic flow may be designated as the value in the key-value pair. Additional or alternative information may be included within one or more data repositories of the segment enforcer (200) without departing from the scope of the invention.

FIG. 3A, FIG. 3B, FIG. 3C, FIG. 3D, and FIG. 4 show flowcharts in accordance with one or more embodiments of the invention. While the various steps in these flowcharts are presented and described sequentially, one of ordinary skill in the art will appreciate that some or all steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the invention.

FIGS. 3A-3C show flowcharts describing a method for internal network threat detection and enforcement in accordance with one or more embodiments of the invention. In Step 300, a network packet is received. In one embodiment of the invention, the network packet may be associated with a traffic flow generated by an application. In one embodiment of the invention, an application may be a software application, or software instructions in the form of non-transitory computer readable program code. The application may be executing on a computing system (see e.g., FIG. 8A and FIG. 8B) residing within the internal network.

In Step 302, the network packet is inspected to obtain packet information. In one embodiment of the invention, the packet information includes at least a portion of the header information associated with the network packet. As such, packet information may include, but is not limited to, a source Internet Protocol (IP) address for the network packet and a destination IP address for the network packet. In one embodiment of the invention, packet information may further include a source port number or identifier from which the network packet was transmitted and a destination port number of identifier to which the network packet is intended to be received. In one embodiment of the invention, packet information may additionally include a payload/packet signature associated with the application from which the network packet was generated.

In one embodiment of the invention, a payload/packet signature may be a pattern of data embedded within each network packet that is generated by a particular application. Accordingly, in one embodiment of the invention, the payload/packet signature may be used to identify the given application with which a network packet is associated. In one embodiment of the invention, the payload/packet signature may also be used to ascertain the task or purpose that which the network packet was assigned. For example, a payload/packet signature may specify that a network packet may have been generated by the BitTorrent software application for the purpose of peer-to-peer file sharing. BitTorrent is a trademark owned by BitTorrent, Inc. In one embodiment of the invention, a payload/packet signature may include a set of attributes and/or rules that further describe the network packet. Examples of the aforementioned attributes include, but are not limited to, the service or protocol used to communicate the network packet (e.g., transmission control protocol (TCP), hypertext transfer protocol (HTTP), file transfer protocol (FTP), secure shell protocol (SSH), etc.), the direction of the corresponding traffic flow (e.g., unidirectional flow from a source to a destination, or a bidirectional flow), the source and/or destination port number(s) (physical and/or logical) from/to which the network packet is transmitted or received, etc.

In Step 304, a flow identifier/ID to be assigned to the network packet is generated using the packet information. In one embodiment of the invention, a flow ID may be string of characters (e.g., letters, numbers, symbols, and/or any combination thereof) that uniquely identifies a particular traffic flow. Accordingly, in one embodiment of the invention, the flow ID assigned to the network packet specifies the traffic flow with which the network packet is associated. In one embodiment of the invention, the flow ID may be the result of a calculation or algorithm specifying the packet information as the independent variable(s). In one embodiment of the invention, the generation of a flow ID to assign to a network packet may only take place when a network packet associated with a traffic flow is observed/received for the first time. In such an embodiment, any subsequent network packet determined to match a previously identified traffic flow is assigned the flow ID of that traffic flow.

In Step 306, a lookup of the flow ID for the network packet (ascertained in Step 304) is performed using a flow ID table. In one embodiment of the invention, a flow ID table may be a data repository (described above) that stores one or more table entries. In one embodiment of the invention, each table entry includes information particular to a traffic flow of which one or more network packet(s) have already been observed/received by the segment enforcer. Further, in one embodiment of the invention, the information particular to a traffic flow may include, at least, (i) the flow ID generated for the traffic flow, and (ii) the current trust/risk scores gauging the current threat level associated with the traffic flow.

In Step 308, a determination is made as to whether the flow ID for the network packet (generated/assigned in Step 304) exists in the flow ID table. In one embodiment of the invention, the determination may be performed by comparing the flow ID for the network packet against the flow ID included in each table entry of the flow ID table. If it is determined that the flow ID for the network packet exists in the flow ID table (e.g., the network packet flow ID matches the flow ID included in one of the table entries of the flow ID table), then the process proceeds to Step 314. On the other hand, if it is determined that the network packet flow ID cannot be found within the flow ID table (e.g., the network packet flow ID does not match the flow ID included in any of the table entries of the flow ID table), then the process proceeds to Step 310.

In Step 310, in determining that the flow ID for the network packet could not be found within the flow ID table, a new table entry is generated. In one embodiment of the invention, the new table entry includes at least the flow ID for the network packet. In one embodiment of the invention, generation of the new table entry may be performed by the decision engine of the segment enforcer (see e.g., 204 in FIG. 2). In Step 312, following the generation of the new table entry, default trust/risk scores are assigned to the network packet. In one embodiment of the invention, the default trust/risk scores may be set to values predetermined by the network administrator of the internal network. In one embodiment of the invention, the default trust/risk scores may be set to values predetermined by the CIC. Moreover, in one embodiment of the invention, the new table entry (generated in Step 310) may be further populated with the default trust/risk scores assigned to the network packet, and thereby the traffic flow with which the network packet is associated.

In one embodiment of the invention, a trust score may provide a confidence level on the trustworthiness of a given source (e.g., subnet, host, and/or computing system) residing within the internal network. This trustworthiness may be based on the nature of the traffic flows originating from the given source. In one embodiment of the invention, a low trust score may indicate that one or more traffic flow(s) from a given source is exhibiting aggressive behavior. In such an embodiment, aggressive behavior may be synonymous with an attack or an attempted attack on or within the internal network. Alternatively, in one embodiment of the invention, a high trust score may indicate that one or more traffic flow(s) from a given source is exhibiting normal behavior.

In one embodiment of the invention, the trust score for a host (or endpoint) is a measure of the probability that a host (or endpoint) is already infected (and/or is actively spreading possible malware within the network) and the trust score for a host (or endpoint) will be set based on the trust scores of the flows originating from the host (or endpoint).

In one embodiment of the invention, a risk score may provide a confidence level on the susceptibility of a given destination (e.g., subnet, host, and/or computing system) residing within the internal network. This susceptibility may be based on the nature of the traffic flows targeted towards (or received by) the given destination. In one embodiment of the invention, a risk score may refer to a probability that a given destination may be compromised in the future. In one embodiment of the invention, a low risk score may indicate that one or more traffic flow(s) directed towards a given destination is exhibiting normal behavior, and thus, the given destination is not vulnerable to infection by network threats. Alternatively, in one embodiment of the invention, a high risk score may indicate that one or more traffic flow(s) directed towards a given destination is exhibiting aggressive behavior. Accordingly, in such an embodiment, the given destination would be increasingly vulnerable to infection by network threats.

In one embodiment of the invention, a risk score of a host (or endpoint) is a measure of the probability that a host (or endpoint) could be infected in the near future, and will be set based on the trust scores of the flows coming into that host (or endpoint) and, e.g., other inputs from graph based ADs.

In one embodiment of the invention, a risk score for a flow is the measure of the probability that the flow may infect the receiving endpoint, which is synonymous with the trust score measure for a flow which is the probability that the flow is carrying a malware payload. In one embodiment of the invention, the risk score for the flow may be computed as (100−trust score for that flow). For examples, if a flow has a trust score of 5, then the risk score for the flow is 95.

### Trust/Risk Score Example

The following is an example of how a trust score and risk may be determined for a given flow. The example is not intended to limit the scope of the invention.

Turning to the example, consider an internal network segment that has the following third-party security solutions: (a) Intrusion Prevention System (IPS), (b) Statistical Anomaly Detection (AD), and (c) Endpoint vulnerability scanner. Further, assume that there are two flows: flow A and flow B in the internal network.

A feature score for each third-party solution output in generated for each flow. For example, the IPS output may be one of the following priority 1, 2, 3 alerts or none. A priority 1 alert implies a possible severe threat(s), a priority 2 alert implies a less severe threat(s) than a priority 1 alert, and a priority 1 alert implies a less severe threat than a priority 2 alert. In this example assume that a priority 1 alert for a flow will generate a feature score of 15 and a priority 2 alert for a flow will generate a feature score of 30. Hence the lower the severity alerts from IPS the higher the feature score for that flow.

For purposes of this example, assume that Flow A leads to a priority 1 alert and a corresponding feature score of 15, while Flow B is inspected and leads to no priority alerts being generated resulting in a feature score of 50.

Further, detailed inspection of Flow A by the Statistical AD results in an output that may trigger an anomaly alert. The presence of an alert from the Statistical AD results in a lower feature score for the flow relative to no alert being generated for the flow. For purposes of this example, assume that Flow A does raise an alert from the Statistical AD, which results in a feature score of 15, and Flow B does not generate any alert, so its feature score is 50.

Finally, based on the output of the endpoint vulnerability scanner, it is determined that one of the source endpoints of Flow A has a severe vulnerability. Thus, Flow A will have a low Endpoint Vulnerability Feature Score of 5. However, the endpoints of Flow B do not have any severe vulnerabilities. Accordingly, the Flow B is assigned a feature score of 60.

In one embodiment of the invention, the segment enforcer may then use a weighted average of these three feature scores as well as the trust score of the endpoint(s) to determine the final trust score for each flow. In this example, weight a1 is for the IPS, weight a2 is for the statistical AD, weight a3 is for the Endpoint vulnerability scanner and weight a4 is for source endpoint trust score. In one embodiment of the invention, the Cloud Intelligence Center computes the weights based on the Machine Learning algorithms trained using sample data sets with live threats. For purposes of this example, the CIC sets the aforementioned weights as follows: a1=0.3, a2=0.3, a3=0.3 and a4=0.1. Further, in this example, also assume that flows A and B endpoints all have an initial trust score of 60.

In view of the above, the trust score for Flow A computed at the segment enforcer is 0.3*15+0.3*15+0.3*5+0.1*60=4.5+4.5+1.5+6=16.5. Further, the trust score for Flow B computed at segment enforcer is 0.3*50+0.3*50+0.3*60+0.1*60=15+15+18+6=54.

Assuming that the threshold for the trust score for suspicious flows is set to 20, Flow A will be reported as suspicious and all (or a subset, as discussed below) of future packets of flow A will undergo detailed inspection while Flow B will not be subjected to detailed packet inspection. The trust score for an endpoint will then be set to lowest trust score of amongst flows emanating from that endpoint. Further, in one embodiment of the invention, the risk score for an endpoint will be set to (100−lowest trust score of all flows terminating that endpoint).

In one embodiment of the invention, the trust score of the endpoint is recomputed (or determined) after the trust scores for the various flows that originate from the endpoint are determined.

Continuing with the discussion of FIG. 3, in Step 314, in determining that the flow ID for the network packet matches the flow ID within one of the table entries of the flow ID table, the current trust/risk scores associated with the flow ID are assigned to the network packet. In one embodiment of the invention, the current trust/risk scores for the flow ID may be obtained from the flow ID table entry identified in Step 308 (e.g., the table entry that included the flow ID matching the network packet flow ID).

Turning to FIG. 3B, after assignment of trust/risk scores to the network packet, in Step 320, a sampling policy for the network packet and/or associated traffic flow is obtained. In one embodiment of the invention, a sampling policy may define the frequency for which a network packet is inspected. In one embodiment of the invention, the frequency of inspection may be based on the current values of the trust/risk scores for the traffic flow with which a network packet is associated. For example, the sampling policy corresponding to a traffic flow with a high trust score and/or low risk score may specify that a network packet (associated with the traffic flow) should be inspected sporadically over a given period of time. Alternatively, the sampling policy corresponding to a traffic flow with a low trust score and/or high risk score may specify that any network packet (associated with the traffic flow) should always be inspected. In one embodiment of the invention, the sampling policy for a traffic flow may be based on the trust/risk scores lying below, above, or any other position relative to one or more threshold(s). In one embodiment of the invention, the one or more threshold(s) may be a predetermined set of values determined by a network administrator or the CIC. In another embodiment of the invention, the one or more threshold(s) may be periodically adjusted during operation of the claimed invention within an internal network. These real-time adjustments may be performed by a network administrator and/or the CIC, and may be based on the threats detected within the internal network.

In one embodiment of the invention, sampling policies may be stored within a data repository of each segment enforcer (see e.g., discussion with respect to FIG. 2). As such, in one embodiment of the invention, a sampling policy for a given traffic flow may be included within a table entry for the traffic flow in the flow ID table. In another embodiment of the invention, a sampling policy may be stored in an alternative storage medium/structure on the segment enforcer and/or CIC.

In one embodiment of the invention, a sampling policy for a network packet and/or associated traffic flow may also serve to optimize the provisioning of computing resources used by a segment enforcer. As discussed above, traffic flows with, for example, low trust scores may have their network packets scrutinized more often and in more detail than network packets associated with traffic flows assigned with higher trust scores. As such, in one embodiment of the invention, this discretion for inspecting select network packets and/or traffic flows may lead to a significant improvement in the real-time performance of threat detection in internal networks over conventional network security solutions. Matter of fact, in most conventional network security solutions, every network packet for every traffic flow is inspected. Based on this policy, conventional network security solutions struggle to achieve high real-time performances due to the sheer amount of network packets encountered within internal networks, and further due to the policy that each of these network packets must be inspected.

In Step 322, a determination is made as to whether the sampling policy specifies that the network packet is to be sampled/inspected. In the event that the network packet is to be inspected, the process proceeds to Step 324. On the other hand, if inspection of the network packet is not necessitated, the process proceeds to Step 328.

In Step 324, upon determining that the network packet is to be sampled/inspected, the trust/risk scores for the network packet (and/or associated traffic flow) are re-evaluated. In one embodiment of the invention, trust/risk scores may be re-evaluated based on score weights obtained from the CIC (see e.g., FIG. 4). Subsequent to their re-evaluation, new trust/risk scores may be obtained for the network packet and/or associated traffic flow. In one embodiment of the invention, these new trust/risk scores may be lower, higher, or equal to the previous trust/risk scores for the network packet and/or associated traffic flow. In one embodiment of the invention, the trust/risk scores for the associated traffic flow, as included in the flow ID table entry corresponding to the flow ID for the traffic flow, may be updated/replaced using the new trust/risk scores.

In Step 326, the sampling policy for the network packet and/or associated traffic flow (obtained in Step 320) is adjusted. In one embodiment of the invention, the sampling policy may be adjusted based on the new trust/risk scores (derived in Step 324). By way of an example, for a given network packet and/or associated traffic flow, the new trust score may have decreased, whereas the new risk score may have remained the same. In this example, the sampling policy may then be adjusted in order to increment the frequency that which network packet(s) from the traffic flow are inspected because the new trust score suggests that the traffic flow may be exhibiting aggressive behavior.

In Step 328, an enforcement action to be applied to the network packet (and/or associated traffic flow) is determined. In one embodiment of the invention, the applied enforcement action may be based on the trust/risk scores for the network packet and/or associated traffic flow. For example, in response to a low trust score and/or high risk score, the appropriate enforcement action may be to block the associated traffic flow from spreading into additional segments of the internal network. Alternatively, in response to a high trust score and/or low risk score, the appropriate enforcement action may be to allow the network packet(s) corresponding to the traffic flow to continue towards their intended destination.

Turning to FIG. 3C, in Step 340, a determination is made as to whether the appropriate enforcement action to apply is to block the associated traffic flow. Given the trust/risk scores for the network packet and/or associated traffic flow, if it is determined that blocking the traffic flow is necessary, the process proceeds to Step 342. On the other hand, if it is determined that allowing the traffic flow to continue towards a destination is acceptable given the trust/risk scores, then the process proceeds to Step 344.

In Step 342, upon determining that the appropriate enforcement action equates to blocking the traffic flow, the network packet (received in Step 300) is dropped. In one embodiment of the invention, dropping the network packet associated with the traffic flow effectively prevents malignant activity/threats stemming from the traffic flow to progress to other segments of the internal network.

In Step 344, information pertaining to the traffic flow is broadcasted. In one embodiment of the invention, the information may include, but is not limited to, the flow ID assigned to the traffic flow, and the trust/risk scores calculated for the traffic flow. In one embodiment of the invention, the aforementioned information may be broadcasted to (or shared with) the CIC and/or other segment enforcers throughout the internal network. In one embodiment of the invention, the sharing of information between the CIC and the segment enforcers, or between a segment enforcer and other segment enforcers, may be implemented using an encrypted zero message queue (ZMQ) socket. In another embodiment of the invention, the sharing of information may be implemented using any other communications transport such as a file, a signal, another socket type, a pipeline, a semaphore, shared memory, a memory-mapped file, etc.

FIG. 3D shows a flowchart describing a method for updating local intelligence in accordance with one or more embodiments of the invention. In Step 360, a broadcast message including information pertaining to a traffic flow (see e.g., Step 344 of FIG. 3C) is received. In one embodiment of the invention, the information within the broadcast message may include, but is not limited to, the flow ID corresponding to a traffic flow existing within the internal network, and the trust/risk scores associated with that traffic flow.

In Step 362, local intelligence with regards to the traffic flow (for which information was received in Step 360) is updated. In one embodiment of the invention, local intelligence may be updated using the information (e.g., flow ID, trust/risk scores, etc.) included in the broadcast message received in Step 360. In one embodiment of the invention, the updating of local intelligence may include updating a local flow ID table. In such an embodiment, at least two options are possible: (i) if the received flow ID matches a flow ID included in one of the table entries of the local flow ID table, the received trust/risk scores for the traffic flow may be used to replace the pre-existing trust/risk scores stored in the identified local flow ID table entry; or (ii) if the received flow ID is found not to match any flow ID recorded in the local flow ID table, a new table entry may be generated, which would include the received flow ID and the received trust/risk scores for the traffic flow for which information was broadcasted.

FIG. 4 shows a flowchart describing a method for adjusting score weights in accordance with one or more embodiments of the invention. In Step 400, threat intelligence and/or telemetry is received/obtained. In one embodiment of the invention, as mentioned above, threat intelligence may refer to consolidated information regarding, but not limited to, network policy violations, malicious or suspicious activities, data traffic anomalies, network intrusions, virus detections, etc. Further, threat intelligence is received/obtained from one or more third-party solution(s). In one embodiment of the invention, telemetry may refer to traffic flow information broadcasted by/from one or more segment enforcer(s). As discussed above, traffic flow information may include, but is not limited to, a flow ID assigned to the traffic flow associated with the broadcasted information, and a most recent/re-evaluated trust/risk scores for that traffic flow.

In Step 402, one or more score weights are adjusted using the received/obtained threat intelligence and/or telemetry. In one embodiment of the invention, a score weight may be a factor assigned/applied to a variable used in the calculation of the trust/risk scores. Further, the score weight determines the relative importance of each variable towards the calculation of the trust/risk scores. In one embodiment of the invention, the score weight(s) may be adjusted through the use of machine learning techniques. In one embodiment of the invention, the score weight(s) may be adjusted using a maximum likelihood estimate (MLE) based classifier. In such an embodiment, the MLE based classifier may use gradient descent methods to adjust the score weight(s) in a cost function representing a weighted combination of the various forms of the threat intelligence and/or telemetry. Examples of the various forms of threat intelligence may include, but are not limited to, outputs received/obtained from: intrusion prevention systems (IPS), statistical anomaly detectors, flow/endpoint vulnerability scanners, etc.

In Step 404, the score weights (adjusted in Step 402) are transmitted to every segment enforcer within the internal network. As mentioned above, in one embodiment of the invention, the transmission or dissemination of the score weights may be achieved through employment of zero message queue (ZMQ) sockets. In another embodiment of the invention, the score weights may be transmitted using any other communications transport such as a file, a signal, another socket type, a pipeline, a semaphore, shared memory, a memory-mapped file, etc.

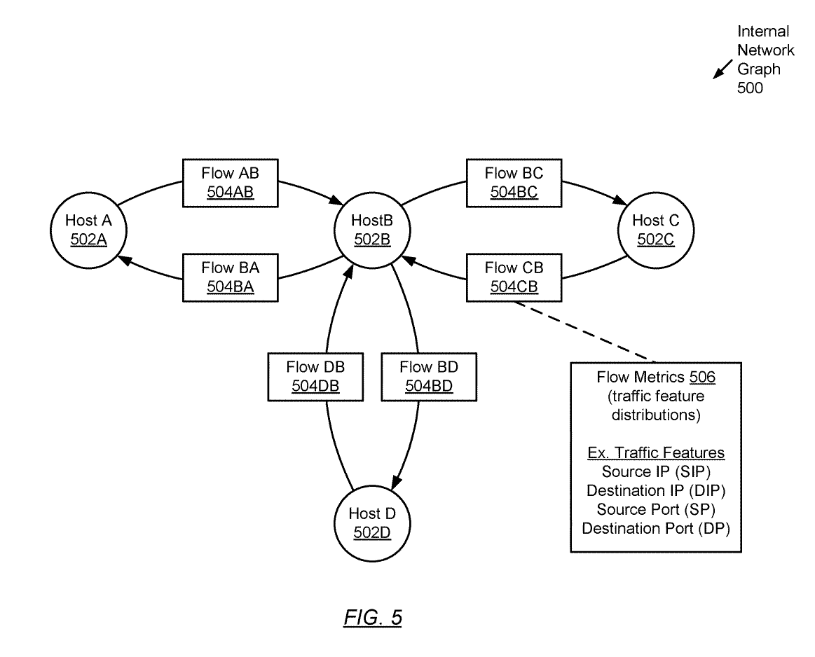

FIG. 5 shows an exemplary internal network graph in accordance with one or more embodiments of the invention. In one embodiment of the invention, an internal network graph may be a connection graph representation of an internal network. Substantively, the internal network graph (500) shown in FIG. 5 is the connection graph representation of the internal network (104) shown in FIG. 1A. Furthermore, as a connection graph, the internal network graph (500) includes two or more nodes (502A, 502B, 502C, 502D) and one or more edges (e.g., 504AB, 504BA, etc.) connecting the nodes together. In one embodiment of the invention, each node (502A, 502B, 502C, 502D) within the internal network graph (500) may be a representation of a host residing in an internal network. Subsequently, each edge (e.g., 504AB, 504BA, etc.) may be a representation of a traffic flow existing between a source node and a destination node. For example, flow DB (504DB) is a graphical representation of a traffic flow originating at Host D (502D) (e.g., a source node) and ending at Host B (502B) (e.g., a destination node).

In one embodiment of the invention, within the internal network graph (500), the real-time dynamics of a traffic flow (or edge) (e.g., 504AB, 504BA, etc.) may be conveyed through one or more flow metric(s) (506). As the internal network graph (500) is maintained based on the observed traffic within the internal network in real-time, the one or more flow metric(s) (506) may be constantly (or periodically) updated. In one embodiment of the invention, the one or more flow metric(s) (506) may be a representation of the dispersal or concentration of traffic feature distributions. One of ordinary skill in the relevant art would recognize that a traffic feature is synonymous with a network packet header field. Examples of fields found in a network packet header include, but are not limited to, a source IP address (SIP) field, a destination IP address (DIP) field, a source port (SP) field, a destination port (DP) field, etc. Subsequently, traffic feature distributions represent changes in the distributional aspects of network packet header fields. Therefore, in one embodiment of the invention, the monitoring of each edge (e.g., 504AB, 504BA, etc.) within the internal network graph (500) for these aforementioned changes in network packet header fields (e.g., flow metric(s) (506)) is key to real-time graph-based statistical anomaly detection (AD).

Further to these aforementioned changes in network packet header fields, one of ordinary skill in the relevant art would recognize that most traffic anomalies induce/cause the dispersal or concentration of these traffic feature distributions within a network. For example, a denial-of-service (DoS) attack may cause a distribution of traffic by DIPs to be concentrated on the victim address. By way of another example, a network scan may induce a dispersed distribution for DIPs, while also causing a concentrated distribution for DPs. Hence, in one embodiment of the invention, in the event that certain traffic feature distribution patterns are detected, threats to/on the internal network may be quickly identified or diagnosed. As such, in one embodiment of the invention, threats may be neutralized, contained, reported, etc., in accordance with the enforcing action appropriate to the circumstance. In one embodiment of the invention, the graph-based AD will be used to generate the trust score for flows (e.g., the output of the graph-based AD will be used to generate a feature score, which may then be used to generate a trust score). For example, if an alert is generated by the graph-based AD for an endpoint exhibiting a graph pattern for a “DDoS attack generator” then the trust score of that endpoint will be dropped to a low value, which in turn affects the scores of the flows emanating from that endpoint that are computed by the segment enforcers.

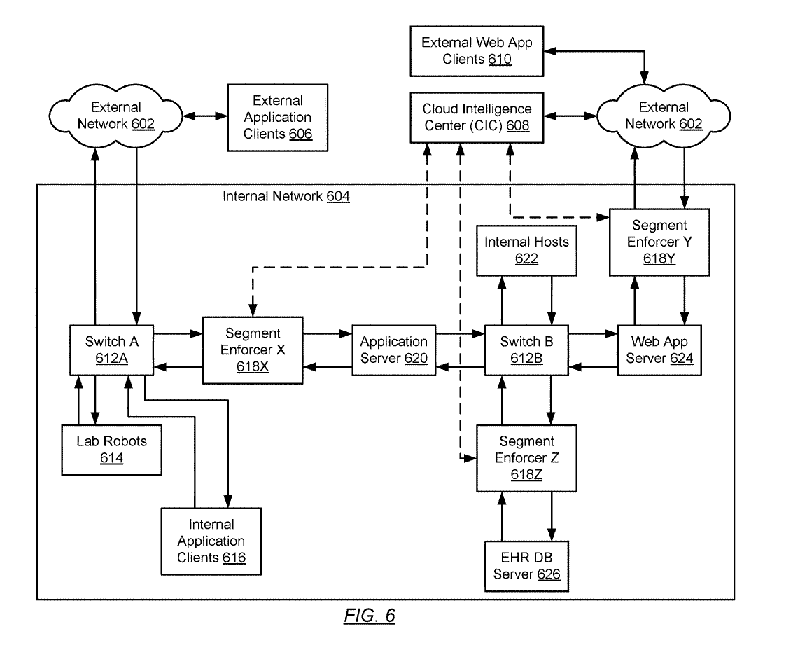

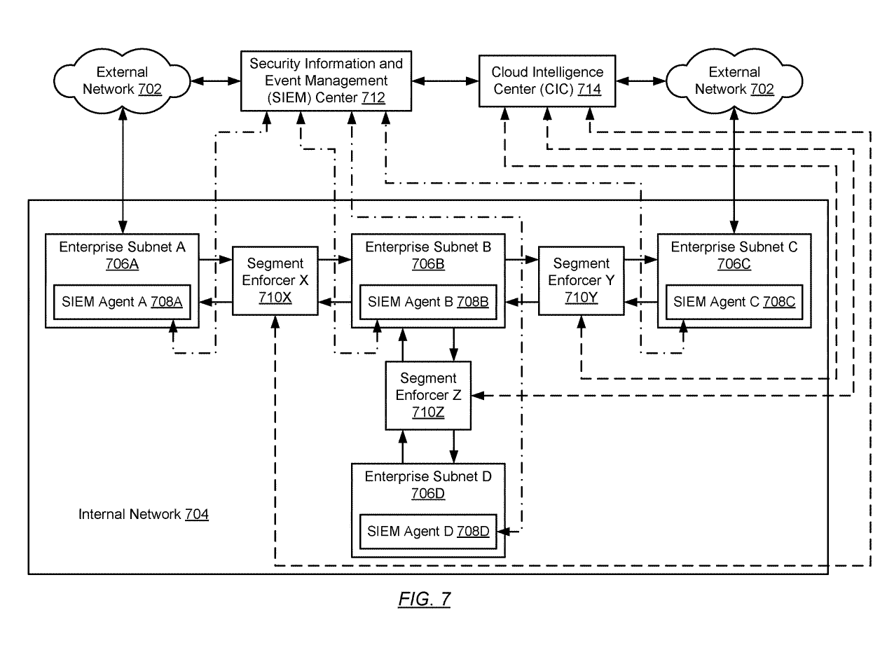

FIG. 6 and FIG. 7 describe examples in accordance with one or more embodiments of the invention. The following examples are for explanatory purposes only and are not intended to limit the scope of the invention.

Turning to FIG. 6, FIG. 6 shows an exemplary deployment of the claimed invention when integrated to perform internal network threat detection and enforcement in a healthcare information technology (IT) environment. The system portrayed includes one or more components residing on an external network (602) operatively connected to one or more components residing within an internal network (604). With regards to a healthcare IT environment, the internal network (604) may include various computing systems (e.g., lab robots (614), an application server (620), an electronic health records (EHR) database server (626), a web-based applications server (624), etc.) that make up the IT infrastructure and/or provide resources not only to internal network users (e.g., internal application clients (616), internal hosts/servers (622), etc.), but also Internet users (e.g., external application clients (606), external web-based application clients (610), etc.) as well. Though there may be additional or alternative measures to detect/counter external threats, the real-time detection and enforcement of internal network threats may be supervised via the CIC (608) in conjunction with the use of several strategically positioned (discussed above) segment enforcers (618X, 618Y, 618Z) throughout the internal network (604). In one embodiment of the invention, each segment enforcer (618X, 618Y, 618Z) thus monitors and protects a segment of the internal network (604). In the example, segment enforcer X (618X) is positioned between switch A (612A) and the application server (620) in order to protect against unauthorized insider breaches via the lab robots (614) or internal application clients (616). Segment enforcer Y (618Y) is positioned between the external network (602) and the web-based applications server (624) so as to protect against web-based structured query language (SQL) injection and cross-site scripting (XSS) breaches. Further, segment enforcer Z (618Z) is positioned between switch B (612B) and the EHR database server (626) in order to protect against unauthorized insider database breaches for personal health records (PHR) or EHR.

FIG. 7 shows an alternative exemplary deployment of the claimed invention. In this example, a generic environment is depicted, which includes an external network (702) operatively connected to an internal network (704). Further, amongst the external network (702), a CIC (714) (described above) is operatively connected to a security information and event management (SIEM) center (712) (e.g., a third-party solution). The components of the internal network (704) include numerous segment enforcers (710X, 710Y, 710Z), and numerous enterprise subnets (706A, 706B, 706C, 706D). Each enterprise subnet subsequently includes one or more hosts (not shown) and a SIEM agent (e.g., 708A, 708B, 708C, 708D). Additionally, each SIEM agent is operatively connected to the SIEM center (712), and thus, periodically transmits reports to the SIEM center (712). The nature of these reports detail the detection of threats and/or malicious activity occurring within a respective enterprise subnet (706A, 706B, 706C, 706D). The SIEM center (712) and/or the several SIEM agents (708A, 708B, 708C, 708D), however, do not include the capability to apply enforcing actions to one or more traffic flow(s) if such threats and/or malicious activities are detected. In order to effectively block traffic flow(s) associated with these threats and/or malicious activities, thereby preventing the spread of network infections to other segments of the internal network, segment enforcers (710X, 710Y, 710Z) are deployed throughout the internal network. In one embodiment of the invention, each segment enforcer (710X, 710Y, 710Z) may act as a gateway for traffic flows between a pair of internal network segments or enterprise subnets. Working in collaboration with the SIEM agents (708A, 708B, 708C, 708D), the SIEM center (712), and/or the CIC (714), each segment enforcer (710X, 710Y, 710Z) may then block one or more traffic flow(s) when the SIEM system (e.g., the SIEM center (712) and the SIEM agents (708A, 708B, 708C, 708D)) detects/reports the occurrence of a threat and/or malicious activity.

Embodiments of the invention may be implemented on a computing system. Any combination of mobile, desktop, server, router, switch, embedded device, or other types of hardware may be used. For example, as shown in FIG. 8A, the computing system (800) may include one or more computer processors (802), non-persistent storage (804) (e.g., volatile memory, such as random access memory (RAM), cache memory), persistent storage (806) (e.g., a hard disk, an optical drive such as a compact disk (CD) drive or digital versatile disk (DVD) drive, a flash memory, etc.), a communication interface (812) (e.g., Bluetooth interface, infrared interface, network interface, optical interface, etc.), and numerous other elements and functionalities.

The computer processor(s) (802) may be an integrated circuit for processing instructions. For example, the computer processor(s) may be one or more cores or micro-cores of a processor. The computing system (800) may also include one or more input devices (810), such as a touchscreen, keyboard, mouse, microphone, touchpad, electronic pen, or any other type of input device.

The communication interface (812) may include an integrated circuit for connecting the computing system (800) to a network (not shown) (e.g., a local area network (LAN), a wide area network (WAN) such as the Internet, mobile network, or any other type of network) and/or to another device, such as another computing device.

Further, the computing system (800) may include one or more output devices (808), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (802), non-persistent storage (804), and persistent storage (806). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (800) in FIG. 8A may be connected to or be a part of a network. For example, as shown in FIG. 8B, the network (820) may include multiple nodes (e.g., node X (822), node Y (824)). Each node may correspond to a computing system, such as the computing system shown in FIG. 8A, or a group of nodes combined may correspond to the computing system shown in FIG. 8A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (800) may be located at a remote location and connected to the other elements over a network.

Although not shown in FIG. 8B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (822), node Y (824)) in the network (820) may be configured to provide services for a client device (826). For example, the nodes may be part of a cloud computing system. The nodes may include functionality to receive requests from the client device (826) and transmit responses to the client device (826). The client device (826) may be a computing system, such as the computing system shown in FIG. 8A. Further, the client device (826) may include and/or perform all or a portion of one or more embodiments of the invention.

The computing system or group of computing systems described in FIG. 8A and 8B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the GUI by a user selecting one or more GUI widgets or inserting text and other data into GUI widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 8A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 8A, while performing one or more embodiments of the invention, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 8A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 8A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 8A and the nodes and/ or client device in FIG. 8B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for threat detection and enforcement in an internal network, comprising:
receiving a network packet of a plurality of network packets for a traffic flow;
inspecting the network packet to obtain packet information;
generating, using the packet information, a flow identifier (ID) for the traffic flow;
assigning, based on the flow ID, a trust score and a risk score for the network packet; and
performing an enforcing action, applicable to the traffic flow, based on the trust score and risk score.

2. The method of claim 1, wherein the packet information comprises a portion of header information included in the network packet.

3. The method of claim 2, wherein the portion of header information comprises a source Internet Protocol (IP) address, a destination IP address, a source port identifier, and a destination port identifier.

4. The method of claim 2, wherein the packet information further comprises a payload/packet signature.

5. The method of claim 4, wherein the payload/packet signature comprises a data pattern unique to an application responsible for generating the traffic flow.

6. The method of claim 1, wherein the assigning of the trust score and the risk score, comprises:
performing, using a flow ID table, a lookup of the flow ID;
determining that the flow ID does not match another flow ID included in any pre-existing flow ID table entries of the flow ID table;
generating, based on the determining, a new flow ID table entry comprising the flow ID and a pair of default score values; and
assigning the pair of default score values as the trust score and the risk score for the network packet.

7. The method of claim 6, wherein the pair of default scores is predetermined by one selected from a group consisting of a network administrator and a cloud intelligence center (CIC).

8. The method of claim 1, wherein assigning of the trust score and the risk score, comprises:
performing, using a flow ID table, a lookup of the flow ID;
determining that the flow ID matches another flow ID included in a pre-existing flow ID table entry of the flow ID table;
obtaining, based on the determining, a pair of current score values from the pre-existing flow ID table entry; and
assigning the pair of current score values as the trust score and the risk score for the network packet.

9. The method of claim 1, further comprising:
between assigning the trust score and the risk score, and performing an enforcing action:
obtaining, based on the trust score and the risk score, a sampling policy for the traffic flow;
determining, based on the sampling policy, to further inspect the network packet;
re-evaluating, based on the determining, the trust score and the risk score using a plurality of score weights to obtain a new trust score and a new risk score for the traffic flow; and
adjusting the sampling policy based on the new trust score and the new risk score.

10. The method of claim 9, wherein the plurality of score weights is derived based at least, in part, on threat intelligence received from a third-party solution.

11. The method of claim 10, wherein the plurality of score weights is further derived based at least, in part, on telemetry from a segment enforcer.

12. The method of claim 9, wherein the sampling policy specifies a frequency for which a sample of the plurality of network packets for the network flow is to be inspected.

13. The method of claim 1, wherein the enforcing action is one selected from a group consisting of blocking the traffic flow, allowing the traffic flow, and reporting the traffic flow.

14. The method of claim 1, wherein performing the enforcing action, comprises:
determining that the trust score lies below a first confidence level threshold and the risk score lies above a second confidence level threshold; and
blocking, based on the determining, the traffic flow from reaching a destination.

15. The method of claim 1, wherein performing the enforcing action, comprises:
determining that the trust score lies above a first confidence level threshold and the risk score lies below a second confidence level threshold; and
allowing, based on the determining, the traffic flow to continue towards a destination.

16. The method of claim 1, further comprising:
broadcasting, to a plurality of entities, the flow ID, the trust score, and the risk score.

17. The method of claim 16, wherein the plurality of entities comprises a plurality of segment enforcers deployed throughout the internal network.

18. The method of claim 17, wherein the plurality of entities further comprises a cloud intelligence center (CIC).

19. The method of claim 16, wherein the broadcasting is implemented using an encrypted zero message queue (ZMQ) socket.

20. The method of claim 16, further comprising:
receiving, from an entity of the plurality of entities, a broadcast message comprising a second flow ID, a second trust score, and a second risk score; and
updating local intelligence for a second traffic flow using the second flow ID, the second trust score, and the second risk score.

21. The method of claim 20, further comprising:
performing a second enforcing action based on the updated local intelligence.

22. A segment enforcer, comprising:
a decision engine executing on a computer processor and configured to:
receive a network packet of a plurality of network packets for a traffic flow;
inspect the network packet to obtain packet information;
generate, using the packet information, a flow identifier (ID) for the traffic flow;
assign, based on the flow ID, a trust score and a risk score for the network packet; and
perform an enforcing action, applicable to the traffic flow, based on the trust score and risk score.

23. The segment enforcer of claim 22, further comprising:
a trust engine operatively connected to the decision engine and a cloud intelligence center (CIC),
the decision engine further configured to:
between assigning the trust score and the risk score, and performing an enforcing action:
obtain, based on the trust score and the risk score, a sampling policy for the traffic flow;
determine, based on the sampling policy, to further inspect the network packet;
delegate, based on the determining, a re-evaluation of the trust score and the risk score to the trust engine;
receive, from the trust engine, a new trust score and a new risk score; and
adjust the sampling policy based on the new trust score and the new risk score,
the trust engine executing on the computer processor and configured to:
obtain a plurality of score weights from the CIC;
generate the new trust score and the new risk score for the traffic flow using the plurality of score weights; and
sharing, with the decision engine, the new trust score and the new risk score.

24. The segment enforcer of claim 22, wherein the decision engine is further configured to:
broadcast, to a plurality of entities, the flow ID, the trust score, and the risk score.

25. The segment enforcer of claim 24, wherein the plurality of entities comprises a cloud intelligence center (CIC) and at least one other segment enforcer.

26. The segment enforcer of claim 24, wherein the decision engine is further configured to:
receive, from an entity of the plurality of entities, a broadcast message comprising a second flow ID, a second trust score, and a second risk score; and
update local intelligence for a second traffic flow using the second flow ID, the second trust score, and the second risk score.

27. A system, comprising:
an internal network comprising a plurality of segments and a plurality of segment enforcers; and
an external network operatively connected to the internal network, and comprising a cloud intelligence center (CIC) and an external network portion of a third-party solution.

28. The system of claim 27, wherein each segment of the plurality of segments comprises a different host residing in the internal network.

29. The system of claim 27, wherein each segment of the plurality of segments comprises a different subnet residing in the internal network.

30. The system of claim 28, wherein a subnet comprises a plurality of hosts and an internal network portion of the third-party solution.

31. The system of claim 30, wherein the internal network portion of the third-party solution is operatively connected to at least one segment enforcer of the plurality of segment enforcers.

32. The system of claim 27, wherein the plurality of segment enforcers and the CIC are operatively connected and communicate via an encrypted zero message queue (ZMQ) socket.

33. The system of claim 27, wherein each segment enforcer of the plurality of segment enforcers is one selected from a group consisting of a computing system and a virtual machine executing on the computing system.

34. The system of claim 33, wherein the computing system is one selected from a group consisting of a host, a network device, and an application-specific device.

35. The system of claim 34, wherein the network device is one selected from a group consisting of a switch, a router, and a multilayer switch.

36. The system of claim 27, wherein a segment enforcer of the plurality of segment enforcers is positioned between a first segment of the plurality of segments and a second segment of the plurality of segments.

37. The system of claim 36, wherein the segment enforcer monitors a plurality of traffic flows between the first segment and the second segment.

38. The system of claim 27, wherein the CIC is one selected from a group consisting of a computing system and a virtual machine executing on the computing system.

39. The system of claim 27, wherein the CIC is operatively connected to the external network portion of the third-party solution.

40. A method for graph-based anomaly detection, comprising:
generating, for an internal network, a connection graph representation of the internal network comprising a plurality of nodes and a plurality of edges;
maintaining, for each edge of the plurality of edges, a plurality of traffic flow metrics based on real-time observations of traffic in the internal network;
detecting an anomaly pattern based on at least one traffic flow metric of the plurality of traffic flow metrics; and
identifying a traffic anomaly based on the anomaly pattern.

41. The method of claim 40, wherein each node of the plurality of nodes represents a host of a plurality of hosts residing in the internal network.

42. The method of claim 40, wherein each edge of the plurality of edges represents a traffic flow between a first node and a second node of the plurality of nodes.

43. The method of claim 40, wherein each traffic flow metric of the plurality of traffic flow metrics comprises one selected from a group consisting of a dispersal and a concentration of a traffic feature distribution.

44. The method of claim 40, wherein the anomaly pattern comprises a specific pattern of at least one traffic feature distribution, wherein the specific pattern is particular to the traffic anomaly.
